(19) United States
(12) Patent Application Publication
(10) Pub. No.: US 2026/0193932 A1
(43) Pub. Date: Jul. 9, 2026

(54) LEAF WITH BLACKOUT SLATS THAT CAN BE INSERTED INTO A FRAME

(71) Applicant: CLOTURES ET PORTAILS DE FRANCE, Flers-en-Escrebieux (FR)

(72) Inventor: David DUPUIS, Genech (FR)

(21) Appl. No.: 19/441,103

(22) Filed: Jan. 6, 2026

(30) Foreign Application Priority Data
Jan. 8, 2025 (FR) FR2500146

(51) Int. Cl. E06B 3/70; E06B 11/02

(52) U.S. Cl. CPC E06B 3/7003; E06B 11/02; E06B 2003/7013

(57) ABSTRACT

A leaf having a frame and blackout slats. The frame has at least two uprights connected by at least one upper crosspiece and by a lower crosspiece. The blackout slats are able to be inserted into the frame in the same vertical plane. At least one of the two uprights and/or at least one of the two crosspieces has a first through opening, which is adapted to allow each blackout slat to be inserted into the frame successively without disassembling the frame and by successively threading each blackout slat through one of its two ends through the first through opening in the upright or crosspiece.

### CROSS REFERENCE TO RELATED APPLICATIONS

This application claims priority to and the benefit of French Patent Application FR2500146, filed January 8, 2025, the entire contents of which are incorporated herein by reference.

### TECHNICAL FIELD

The present disclosure relates to the manufacture of a leaf having a frame and blackout slats that can be inserted into said frame. The main application of the disclosure is in the manufacture of a leaf for a driveway gate or pedestrian gate.

### PRIOR ART

Pedestrian gate or driveway gate leaves are known to be manufactured with a rigid frame made up of at least two uprights and two crosspieces connecting the two uprights, and with horizontal and/or vertical and/or oblique blackout slats inserted in the frame in the same vertical plane.

Until now, pedestrian gate and driveway gate leaves have been manufactured by fitting the blackout slats into the frame, even though the frame has not yet been fully assembled. For example, the upper crosspiece is not yet attached between the two uprights of the frame during the installation of the blackout slats, and is only attached once all the blackout slats have been installed.

In practice, this manufacturing method means (first disadvantage) that all frame assembly and filling operations with blackout slats must be carried out on the same production site.

This method also complicates (second disadvantage) the manufacture of the leaf, since it requires a final frame assembly operation once all the blackout slats have been fitted.

Furthermore (third disadvantage), when it is desired to replace a blackout slat, for example with a new blackout slat, or with a different blackout slat to achieve a different visual effect, it is theoretically necessary to dismantle the leaf, and disassemble at least part of the frame to remove said blackout slat, and then reassemble the frame once said blackout slat has been replaced. These operations are very time-consuming, and in practice are generally not carried out.

Japanese patent application JP2007 039931 A discloses a sliding door including a frame in which one of the vertical uprights has a plurality of through openings distributed over the height of the upright. Each through opening is necessarily associated with a single blackout slat, which can slide horizontally through its associated through opening. The aim of this publication is to allow a blackout slat to slide horizontally in relation to the frame, thus creating an opening in the door for a letter or parcel to pass through. Each blackout slat necessarily includes a handle to allow the blackout slat to be manipulated when a user wishes to slide it through its associated opening. This handle prevents the blackout slat from being threaded through the associated through opening at one end, without disassembling the frame of the leaf.

Japanese patent application JP H07 127353 A discloses a skylight comprising a fixed frame wherein V-shaped slats (3) are mounted. The two uprights of the skylight frame have V-shaped through openings distributed over the height of the uprights, allowing each slat to be mounted in the skylight frame. On the one hand, this skylight is not a leaf, but an insert designed to be inserted into an ad hoc door opening. On the other hand, as in the aforementioned Japanese patent application JP2007 039931 A, each V-shaped through opening is necessarily associated with a single blackout slat that can slide horizontally through its associated through opening.

### SUMMARY

An exemplary aspect of the present disclosure relates to a leaf comprising a frame and blackout slats, said frame comprising at least two uprights connected by at least one upper crosspiece and by a lower crosspiece, and said blackout slats being able to be inserted into said frame in the same vertical plane. At least one of the two uprights and/or at least one of the two crosspieces has a first through opening, which is adapted to allow each blackout slat to be inserted into the frame successively without disassembling the frame and by successively threading each blackout slat through one of its two ends through said first through opening in the upright or crosspiece.

Advantageously, an aspect of the present disclosure makes it possible to fill the frame of the leaf with the blackout slats once the frame has been assembled and without having to disassemble the frame, which simplifies the manufacture of the leaf and also advantageously makes it possible to carry out the frame filling operations on the same site as the frame assembly or on another site.

An aspect of the present disclosure allows a single assembled frame to be quickly and easily customized with a leaf with blackout slats that can be selected at the customer's request.

An aspect of the present disclosure makes it possible to replace a blackout slat, for example with a new blackout slat, or with a different blackout slat to achieve a different visual effect, without having to disassemble the frame.

More particularly, the leaf of an aspect of the present disclosure may comprise the following additional and optional features, each additional and optional feature being combinable with any of the other technical features of the leaf:

Said first through opening is adapted to allow the frame to be removed successively from each blackout slat, without disassembling the frame, and by passing each blackout slat through said first through opening in the upright or crosspiece.

Each blackout slat can be inserted so that it slides in the frame of the leaf.

The blackout slats can be inserted horizontally into the frame, through said first through opening, one above the other in the same vertical plane, either abutting or not abutting.

Said first through opening in the upright of the frame is positioned in the upper part of the upright of the frame.

Each blackout slat can be inserted horizontally into the frame through said first through opening and, once inserted, can slide vertically in the two uprights of the frame.

The leaf includes a mullion which vertically connects the two crosspieces, and which has at least one second through opening, adapted to allow the passage of a blackout slat through the mullion, without disassembling the frame.

Each blackout slat can be inserted horizontally into the frame through said first through opening and, once inserted, can slide vertically in one of the uprights of the frame and in the mullion of the frame, either abutting or not abutting

The blackout slats can be inserted vertically and/or obliquely into the frame, side by side in the same vertical plane.

Once inserted in the frame, the blackout slats can be either abutting or not abutting.

Each blackout slat can be inserted vertically into the frame and, once inserted, can slide horizontally in the two crosspieces of the frame.

The leaf has at least one closing cover, which is adaptable to the frame so as to close said first through opening or which is mounted on the frame and can be moved with respect to the frame, so as to close said first through opening.

The aforementioned closing cover can be removed from the frame or moved with respect to the frame to free up said first through opening.

The leaf has at least one closing cover, which is adaptable to the frame so as to close said second through opening of the mullion or which is mounted on the frame and can be moved with respect to the frame, so as to close said second through opening of the mullion.

Said closing cover for closing the second through opening of the mullion can be removed from the frame or moved with respect to the frame so as to free said second through opening of the mullion.

The cross-section of said first through opening and/or, if applicable, the cross-section of said second through opening is slightly larger than the cross-section of the blackout slats.

The leaf forms a pedestrian gate leaf or a driveway gate leaf.

An aspect of the present disclosure also relates to a method of manufacturing the above-mentioned leaf, wherein the frame of the leaf is pre-assembled, and each blackout slat is successively inserted into the frame, without disassembling the frame, and by successively threading each blackout slat by at least one of its two ends through said first through opening of an upright or a crosspiece of the frame.

In particular, the first through opening in the upright or crosspiece of the frame is closed by a cover plate once the blackout slats have been mounted in the frame.

More particularly, when the frame has a mullion, which connects the upper and lower crosspieces of the frame and which comprises a through opening, a plurality of blackout slats are also passed successively through said second through opening of the mullion of the frame of the leaf.

More particularly, the second through opening in the mullion of the frame is closed by means of a cover plate, once the blackout slats have passed through the mullion.

### BRIEF DESCRIPTION OF THE DRAWINGS

Other features and advantages will become more clearly apparent on reading the detailed description below of several alternative embodiments according to the present disclosure, a detailed description that is given by way of non-limiting and non-exhaustive example, and with reference to the appended drawings, in which:

- FIG. 1 is a front view of an example of a bare frame of a pedestrian gate leaf, without the blackout slats.

- FIG. 2 is an isometric cross-sectional view of the frame of FIG. 1 in the cross-sectional plane II-II.

- FIG. 3 is a right-hand view of the right-hand upright (receiving upright) of the frame shown in FIG. 1.

- FIG. 4 is a left view of the left upright (hinge upright) of the frame shown in FIG. 1.

- FIGS. 5 to 9 show the main steps involved in mounting the blackout slats in the pedestrian gate frame shown in FIG. 1.

- FIG. 10 shows an enlarged view of the right-hand upright (receiving upright) of the frame shown in FIG. 1, and its closing cover, before the cover plate is fitted to the upright.

- FIG. 11 is an isometric cross-sectional view of the frame of FIG. 9 in the cross-sectional plane XI-XI.

- FIG. 12 shows a front view of an example of a sliding bare driveway gate leaf frame, without the blackout slats.

- FIG. 13 is a right-hand view of the right-hand upright (receiving upright) of the frame shown in FIG. 12.

- FIG. 14 is a left-hand view of the left-hand upright (free-end upright) of the frame shown in FIG. 12.

- FIGS. 15 to 23 show the main steps involved in mounting the blackout slats in the frame of the driveway gate leaf shown in FIG. 12.

- FIG. 24 is an isometric cross-sectional view of the frame of FIG. 23 in the cross-sectional plane XXIV-XXIV.

- FIG. 25 is a perspective view of a bare driveway gate leaf frame, without the blackout slats, to better visualize the through openings for the blackout slats in the upright and the mullion.

- FIG. 26 is a front view of a pedestrian gate leaf with vertical blackout slats.

### DETAILED DESCRIPTION

### Example of pedestrian gate leaf 1A

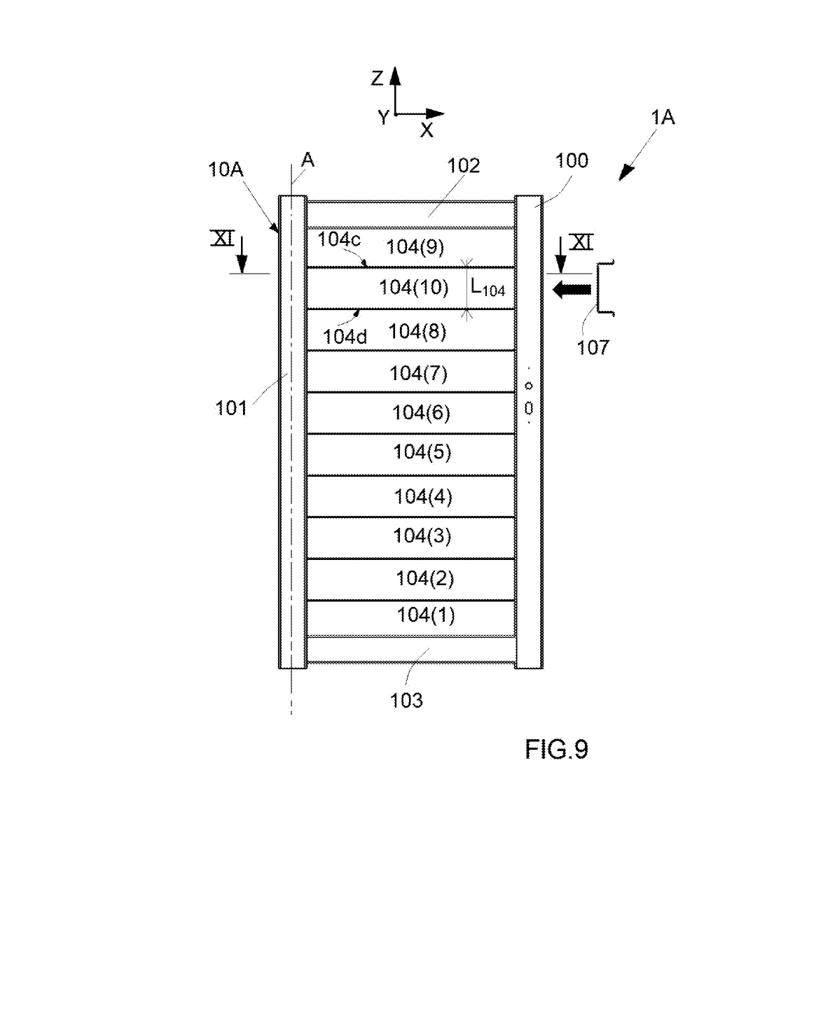

FIG. 9 shows an example of a pedestrian gate leaf 1A, which conforms to an aspect of the present disclosure.

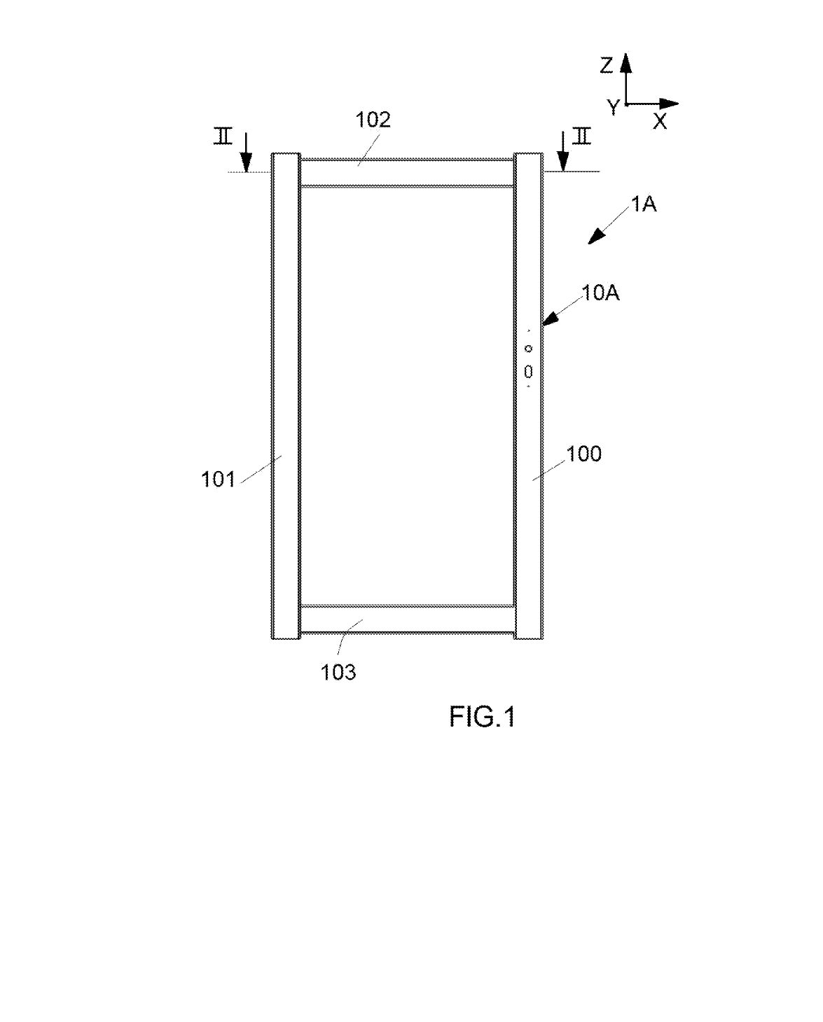

This pedestrian gate leaf 1A includes (Fig.1 and Fig.9) a frame 10A into which horizontal blackout slats 104 positioned in the same vertical plane are inserted.

In the attached figures, the number in parentheses after each reference 104 characterizes the order of insertion of the blackout slat 104 into the frame 10A.

The frame 10A is formed by the assembly of at least two vertical uprights 100 and 101 connected by a horizontal upper crosspiece 102 and a horizontal lower crosspiece 103.

The upright 100 in FIG. 1 is also referred to as the receiving upright, and the upright 101 in FIG. 1 is also referred to as the hinge upright. The pedestrian gate leaf 1A is usually designed for pivoting about a vertical axis A (Fig.9).

Alternatively, the leaf 1A could be a sliding leaf.

The uprights 100, 101 and the crosspieces 102, 103 are, for example, profiles which are preferably made of metal, such as steel or aluminum.

The material used to make up the uprights 100, 101 and crosspieces 102, 103 is not, however, limiting with respect to the disclosure. The uprights 100, 101 and the crosspieces 102, 103 can for example also be made of plastic and/or wood and/or wood composite (mixture of wood fibers and polymer(s)).

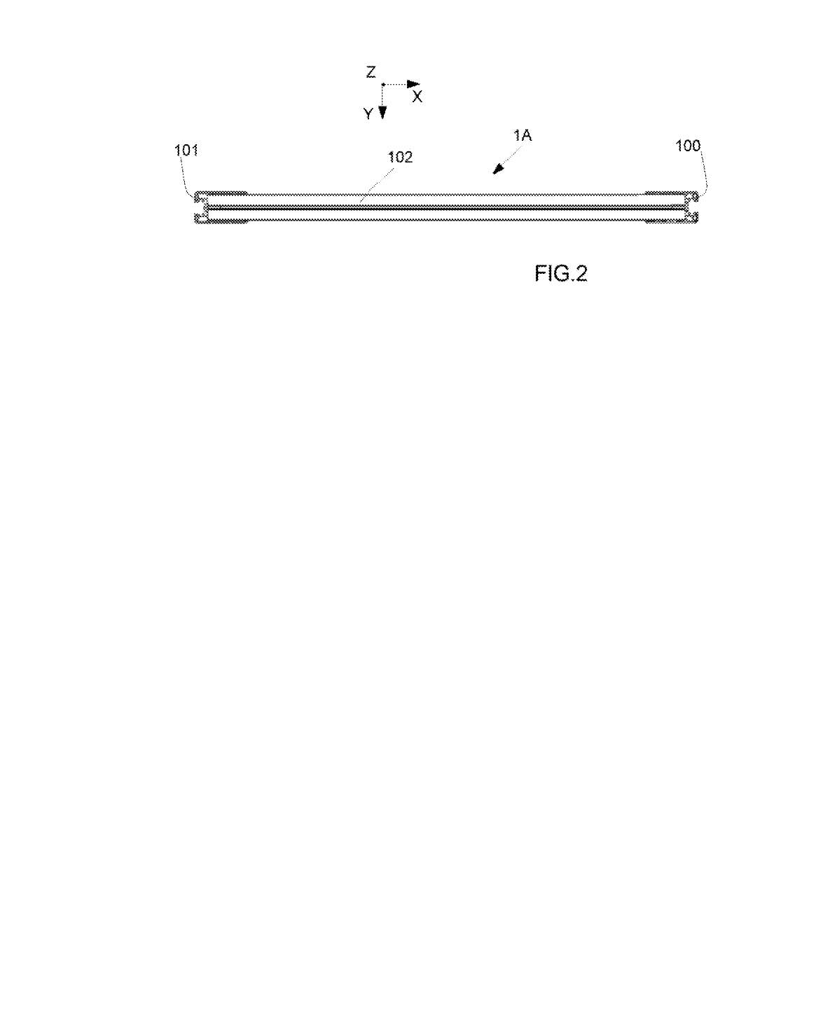

Referring to FIG. 2, each upright 100 and 101 has a longitudinal rebate 105 delimited by a bottom wall 105a and two side walls 105b.

The ends of the crosspieces 102, 103 are inserted into the rebates 105 of the two uprights 100, 101 and are connected to the uprights 100, 101 by any means, for example by screwing and/or bolting and/or welding.

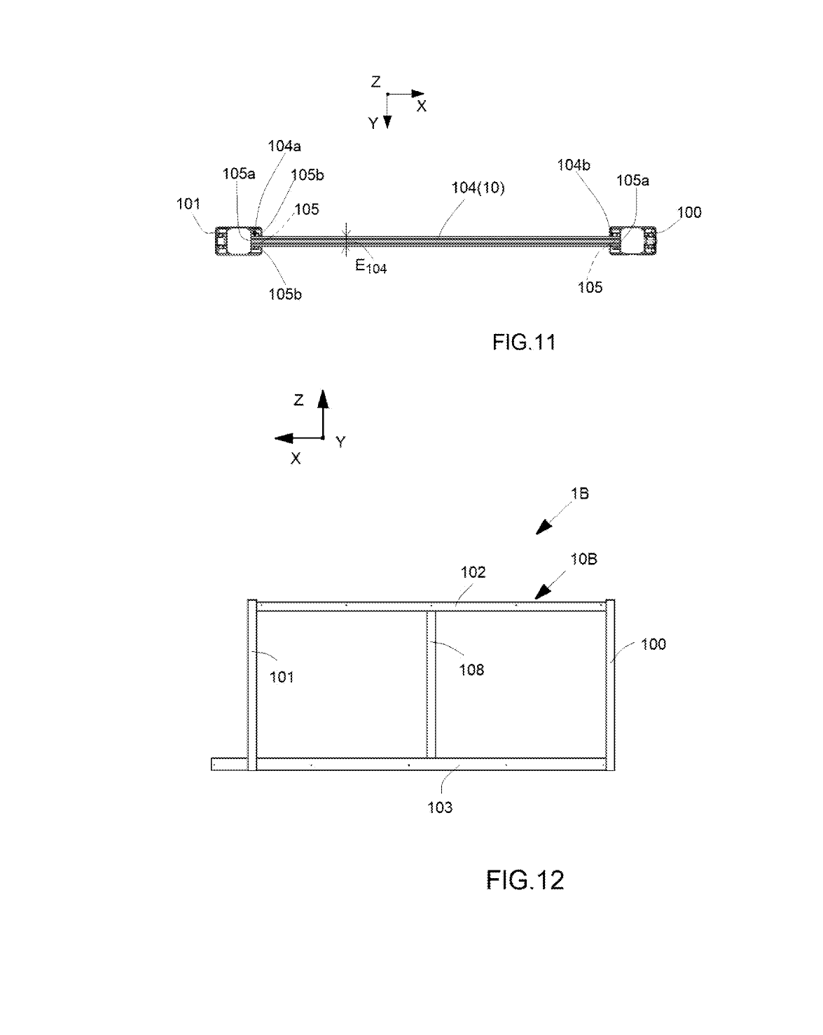

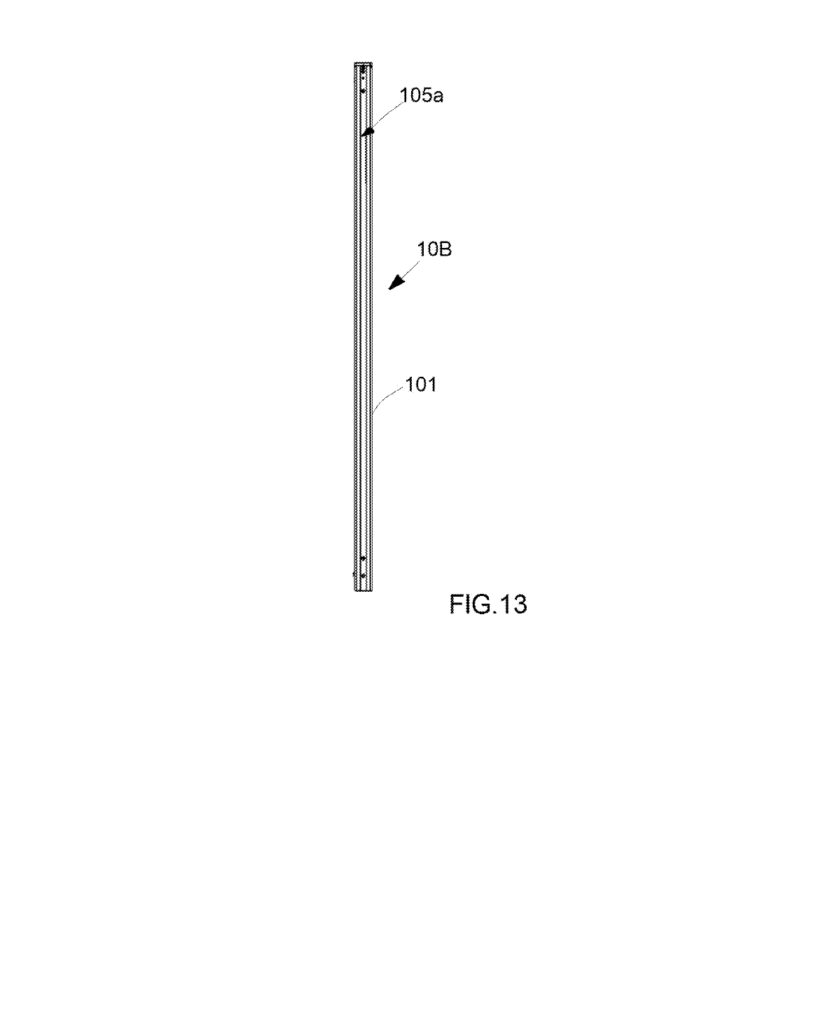

In the particular example shown in FIG. 9, the blackout slats 104 are rectangular in shape, with width L₁₀₄ and thickness E₁₀₄ (Fig.11)

In the particular example shown in FIG. 9, the blackout slats 104 are positioned horizontally in the frame 10A, overlapping one another in pairs.

The longitudinal edges 104c, 104d of the blackout slats 104 can be designed to allow two adjacent slats to fit edge-to-edge in the same plane. However, this edge-to-edge interlocking of the blackout slats 104 is optional and not essential to one or more aspects of the prsent disclosure. In particular, the blackout slats 104 can be stacked one on top of the other, without being nested in one another.

More particularly, with reference to FIG. 11, the two ends 104a, 104b of each blackout slat 104 are slid vertically one above the other into the rebates 105 of the uprights 100, 101.

The method of manufacturing the blackout slats and the material of which the blackout slats 104 are made are not limiting with respect to one or more aspects of the present disclosure.

The blackout slats 104 can be made from a variety of materials. For example, and in a non-limitative and non-exhaustive way with respect to the disclosure, the blackout slats 104 can be made of plastic, in particular PVC, wood, composite wood (mixture of wood fibers and polymer(s)), metal.

The blackout slats 104 are not necessarily all identical. The blackout slats 104 can be solid or hollow. The blackout slats 104 can be perforated. The blackout slats 104 can be opaque, translucent or transparent.

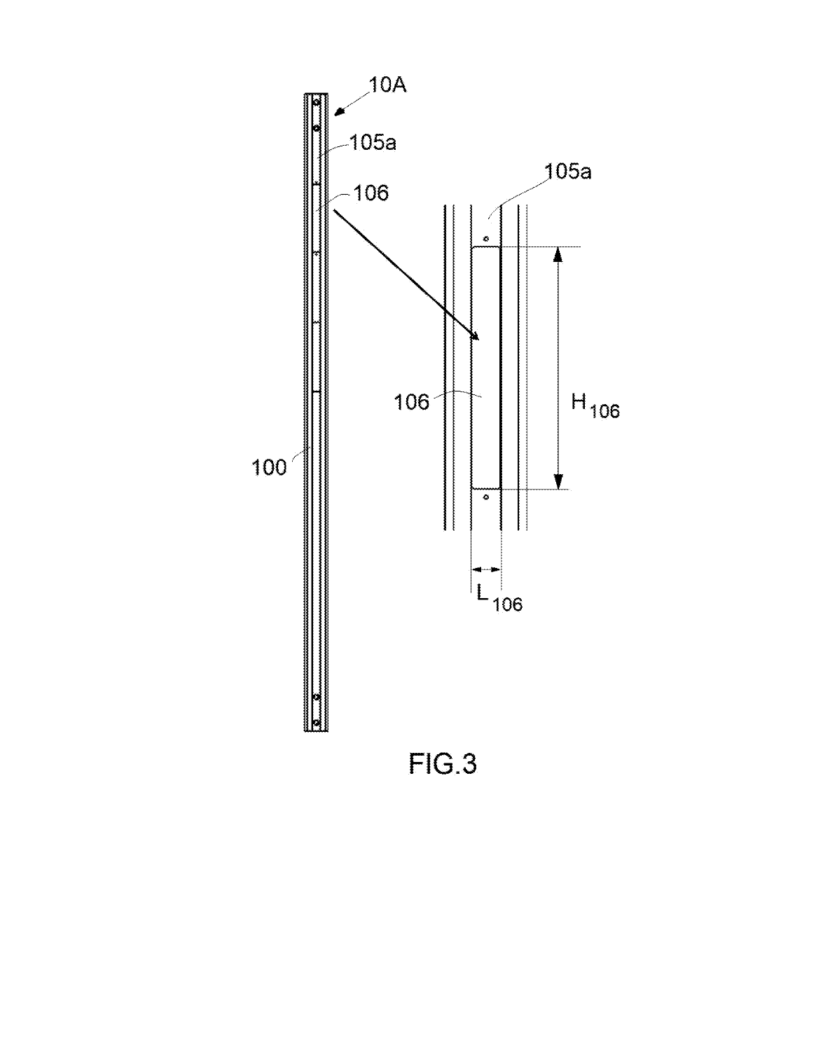

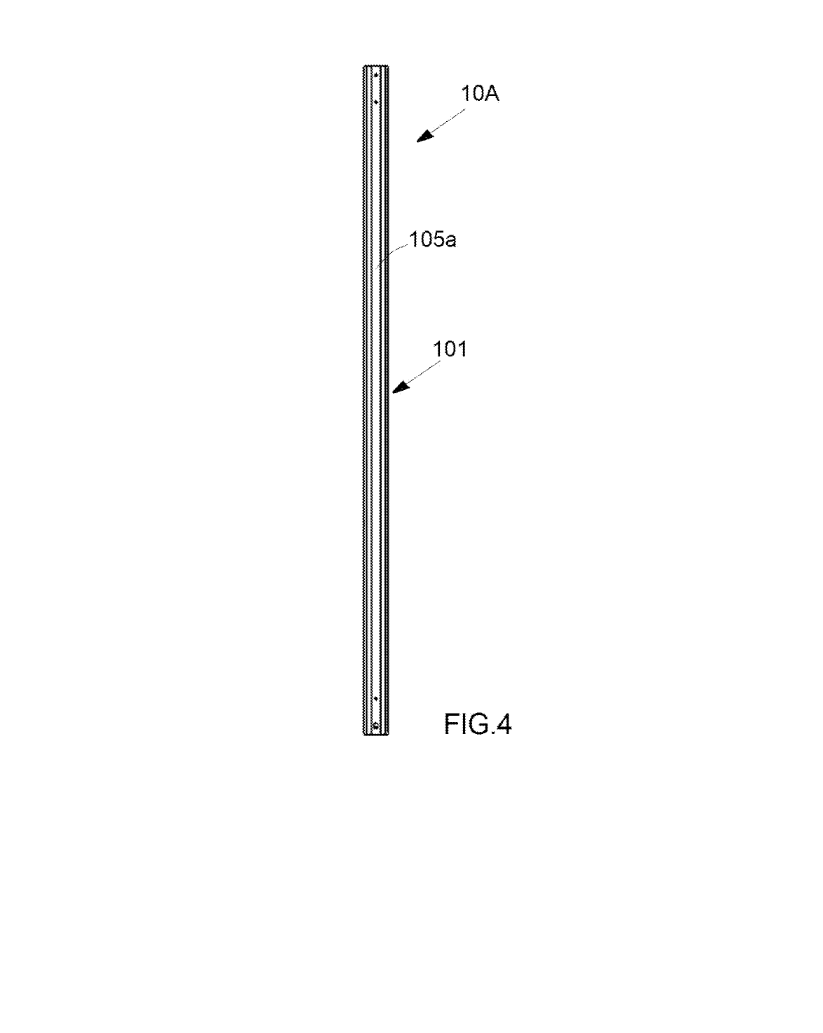

Referring to FIG. 3, the top part of the receiving upright 100 has a through opening 106 in the bottom wall 105a of the rebate 105.

This through opening 106 has a rectangular cross-section of height H₁₀₆ and width L₁₀₆.

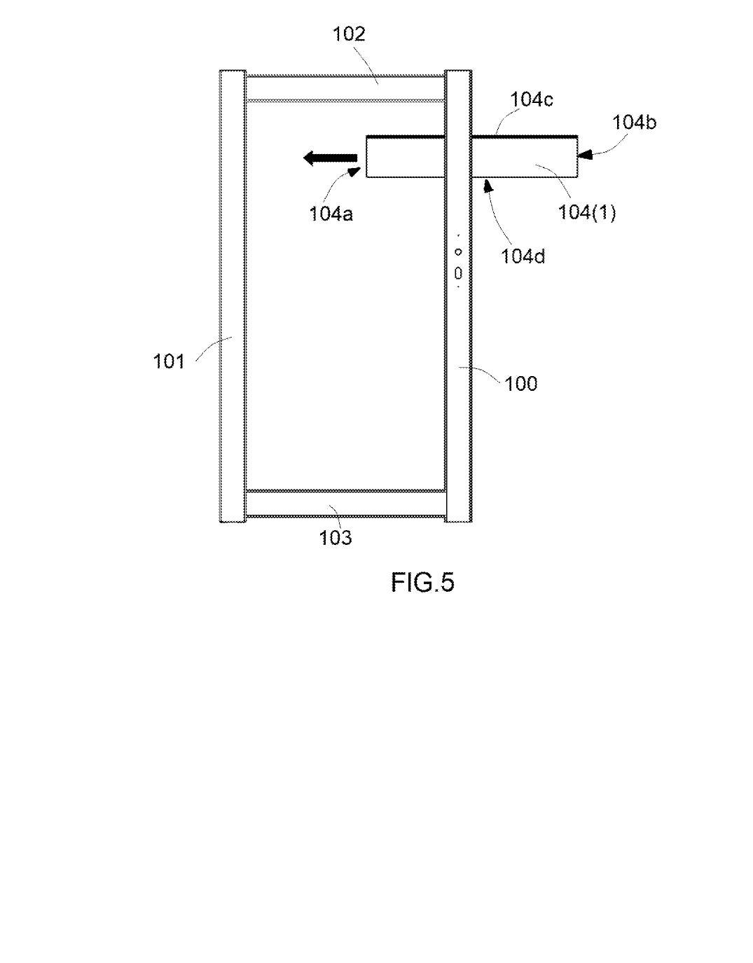

The height H₁₀₆ is greater than, and preferably slightly greater than, the width L₁₀₄ of each blackout slat 104. The width L₁₀₆ is greater than, and preferably slightly greater than, the thickness E₁₀₄ of each blackout slat 104. The cross-section of the through opening 106 is thus adapted to the cross-section of the blackout slats 104, allowing each blackout slat 104 (FIG. 5 to Fig.9) to be inserted successively into the frame 10A without disassembling the frame, and by threading each blackout slat at one of its two ends through the through opening 106 in the receiving upright 100.

With reference to FIGS. 5 to 11, the blackout slats 104 can be mounted in the frame 10A without disassembling the frame 10A, using the following successive steps.

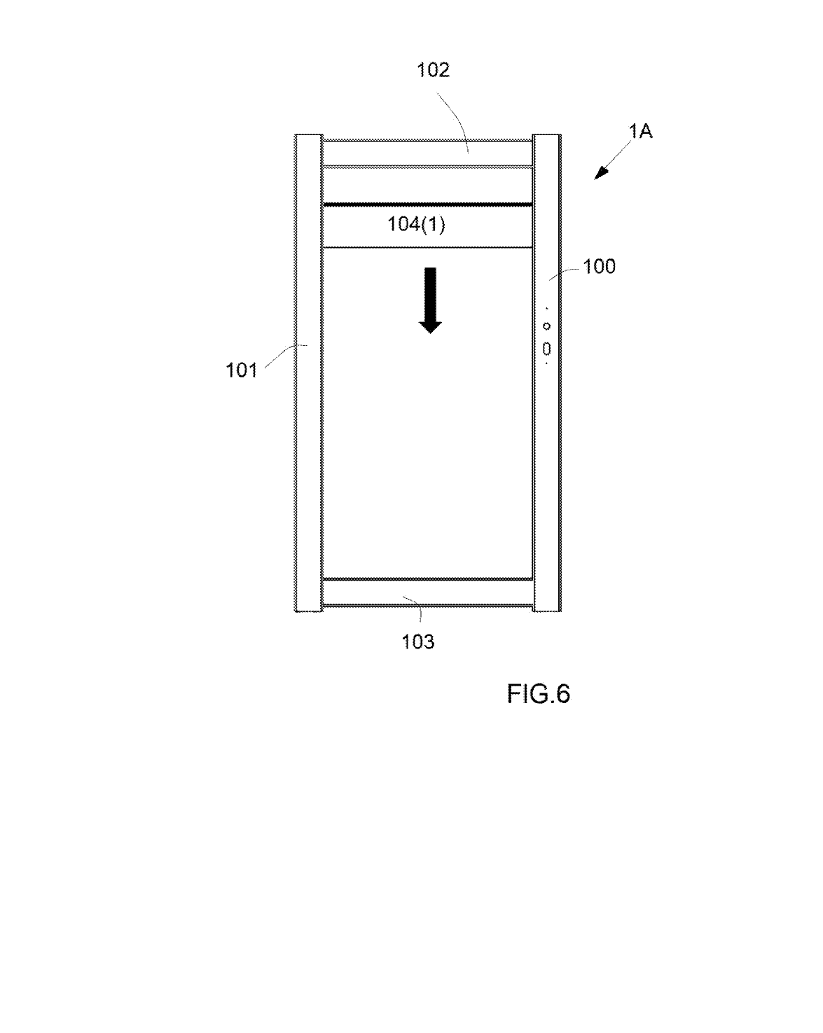

### Fig.5 and Fig.6:

A first blackout slat 104(1) is threaded horizontally (Fig.5) through the through opening 106 of the upright 100, until (Fig.6) the front end 104a of the blackout slat is inserted into the rebate 105 of the hinge upright 101 and the rear end 104b of the blackout slat is positioned in the rebate 105 of the receiving upright 100.

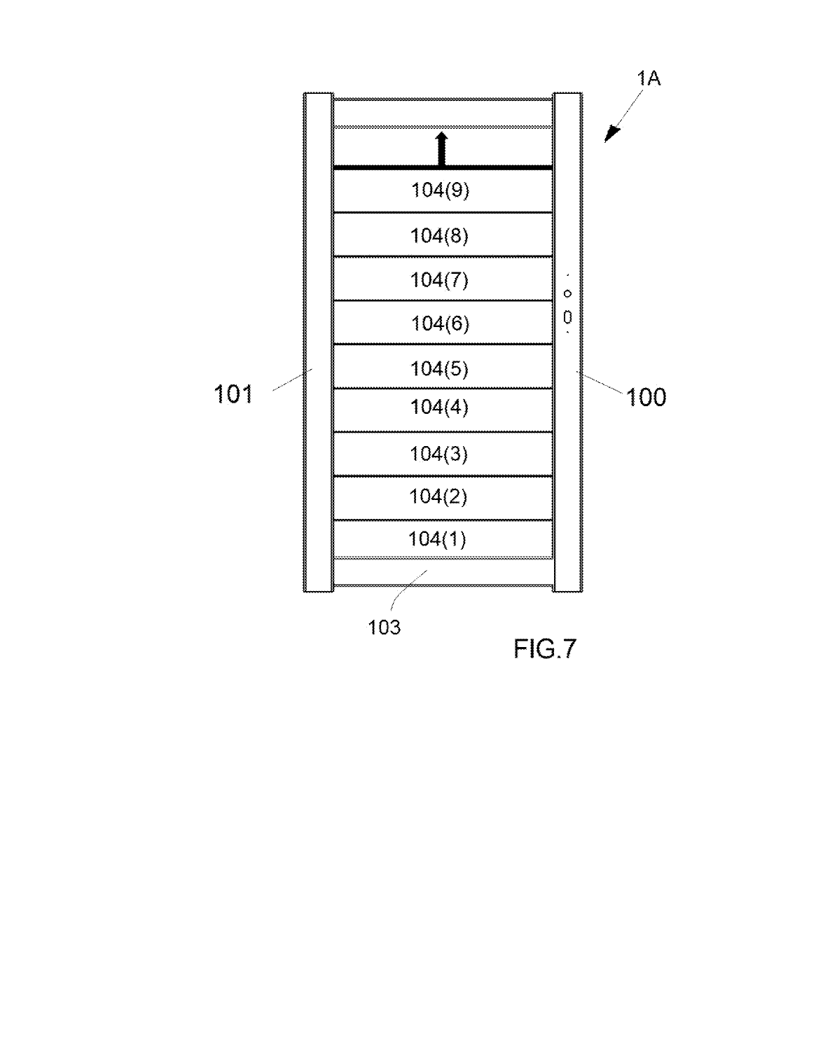

### Fig.6 and Fig.7:

This first blackout slat 104(1) is then (Fig.6) slid vertically downwards (Fig.7) to the bottom crosspiece 103, sliding and guiding it in the rebates of the two uprights 100, 101 of the frame 10A.

The above operations are repeated with each of the blackout slats 104(2) to 104(9), so that they are superimposed in pairs in the frame 10A, as shown in FIG. 7.

In the configuration shown in FIG. 7, the slat 104(9) in the uppermost position in the frame 10A closes the through opening 106 in the upright 101.

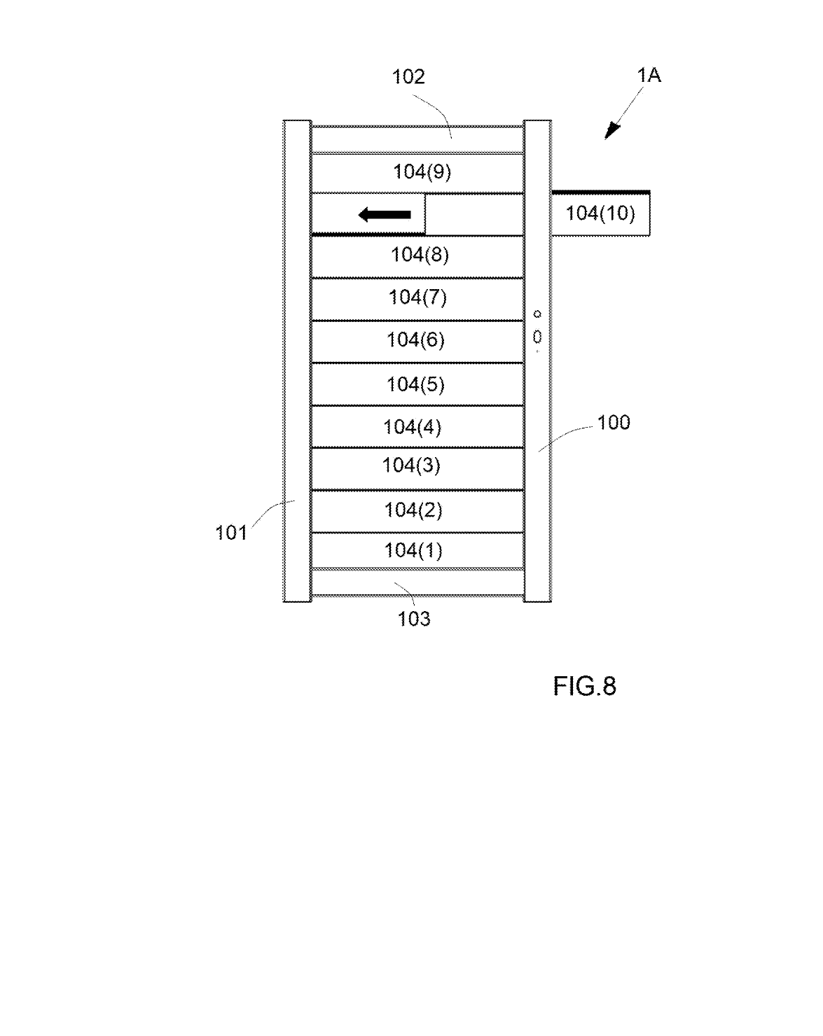

### Fig.8:

Then, in order to be able to insert the last slat 104(10) into the frame 10A, this blackout slat 104(9) is slid upwards, so as to free the through opening 106, then the last blackout slat 104(10) is threaded horizontally into the frame 10A through the through opening 106, between the two blackout slats 104(8) and 104(9).

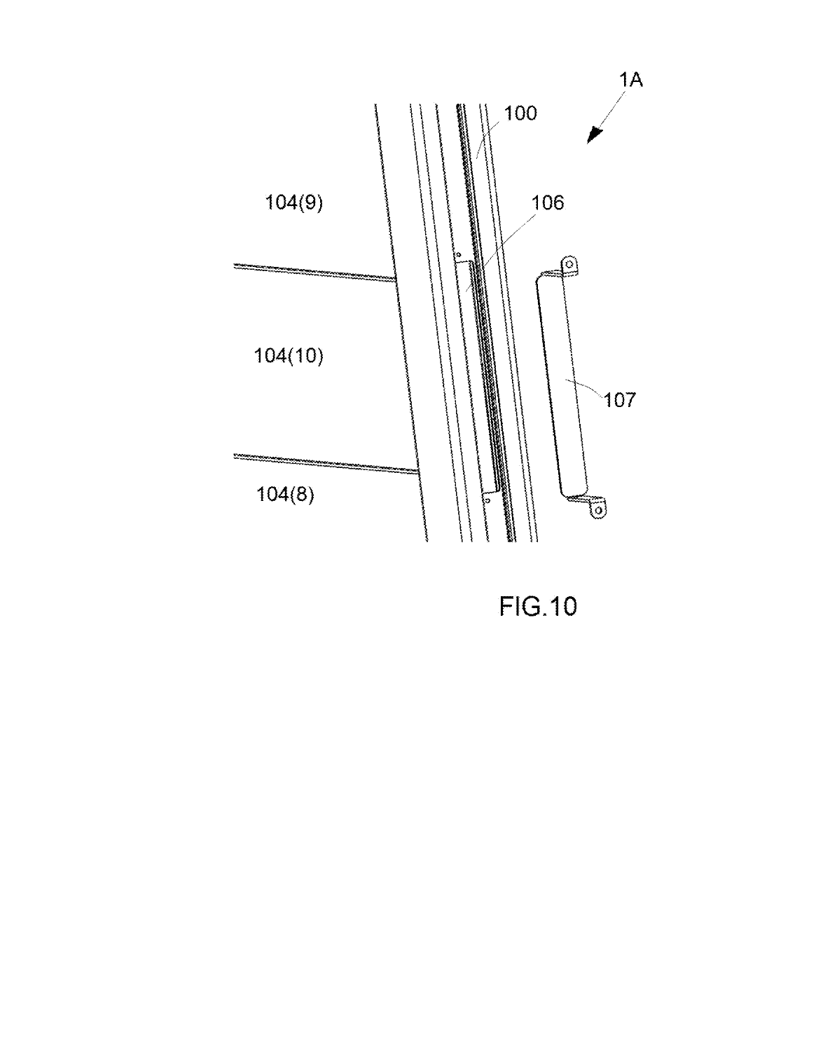

### Fig.9 and Fig.10:

An add-on cover plate 107 (closing part) is attached to the receiving upright 100 of the frame 10A, for example by screwing and/or clipping it onto the upright 100, so as to close said through opening 106.

This cover plate 107 can be permanently attached to the frame 10A once the slats 104 have been mounted in the frame 10A.

However, it is advantageous for this cover plate 107 to be removably attached to the frame 10A, so that one or more blackout slats 104 can be removed. This removal can be useful when one or more slats 104 of the pedestrian gate leaf 1A are to be replaced.

When the cover plate 107 is removable, the blackout slats 104 can advantageously be removed from the frame 10A without disassembling the frame 10A, by temporarily removing the cover plate 107 so as to free the through opening 106 and successively passing the blackout slat(s) through the through opening 106 of the upright 100.

### Example of driveway gate leaf 1B

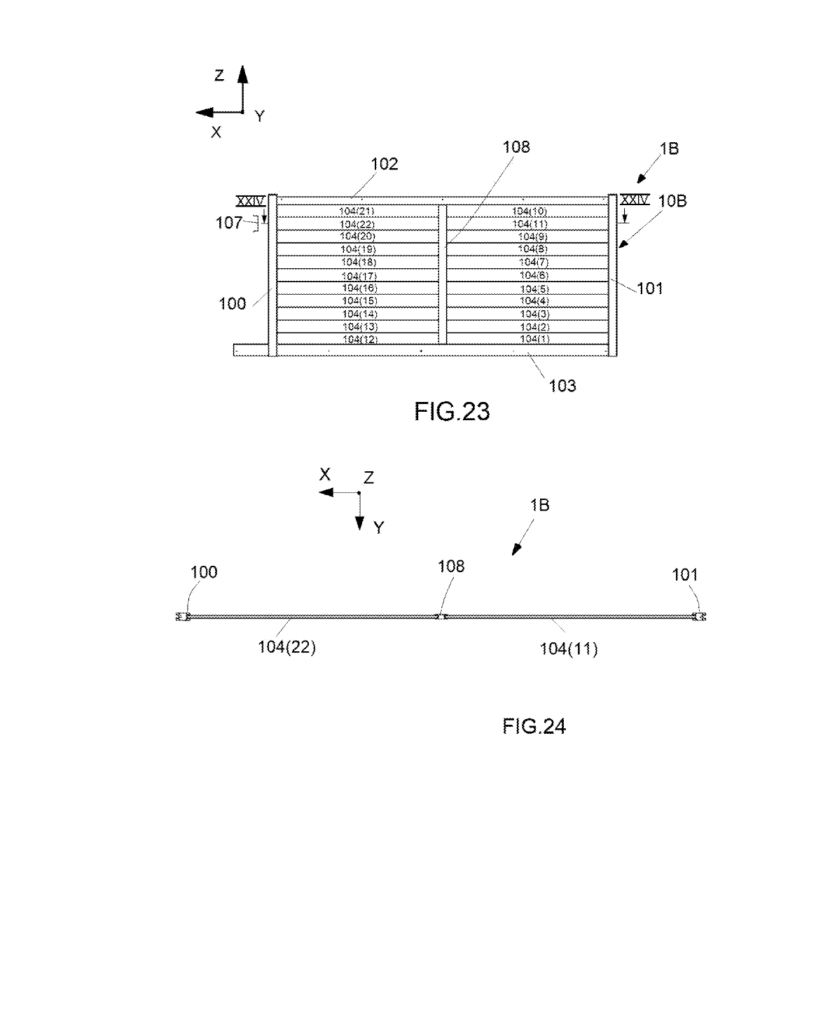

FIG. 23 shows an example of a sliding driveway gate leaf 1B which conforms to an aspect of the present disclosure.

This driveway gate leaf 1B includes (FIG.12 AND FIG.23) a frame 10B into which horizontal blackout slats 104 positioned in the same vertical plane are inserted.

In the attached figures, the number in parentheses after each reference 104 characterizes the order of insertion of the blackout slat 104 into the frame 10B.

The above description of the blackout slats 104 of the pedestrian gate leaf 1A applies mutatis mutandis to the blackout slats 104 of the driveway gate leaf 1B and will therefore not be repeated.

As for the abovementioned pedestrian gate leaf 1A, the frame 10B is formed by the assembly of at least two vertical uprights 100 and 101 connected by a horizontal upper crosspiece 102 and a horizontal lower crosspiece 103. The upright 100 in FIG. 12 is also referred to hereinafter as the free-end upright, and the upright 101 in FIG. 12 is also referred to as the receiving upright.

This frame 10B also includes an intermediate upright 108, more commonly referred to as a "mullion". This mullion 108 connects and consolidates the two crosspieces 102 and 103 in their central part.

The driveway gate 1B can be provided in the usual way for sliding (horizontal X axis), and in particular can be motorized for sliding.

Alternatively, an aspect of the present disclosure can also be applied to the production of a swing gate leaf.

As for the driveway gate leaf 1A, the uprights 100, 101, crosspieces 102, 103 and mullion 108 can be profiles which are preferably made of metal, for example steel or aluminum. The materials used to make up the uprights 100, 101, crosspieces 102, 103 and mullion 108 are not, however, exhaustive. The uprights 100, 101, crosspieces 102, 103 and mullion 108 can also be made of plastic and/or wood and/or wood composite, for example.

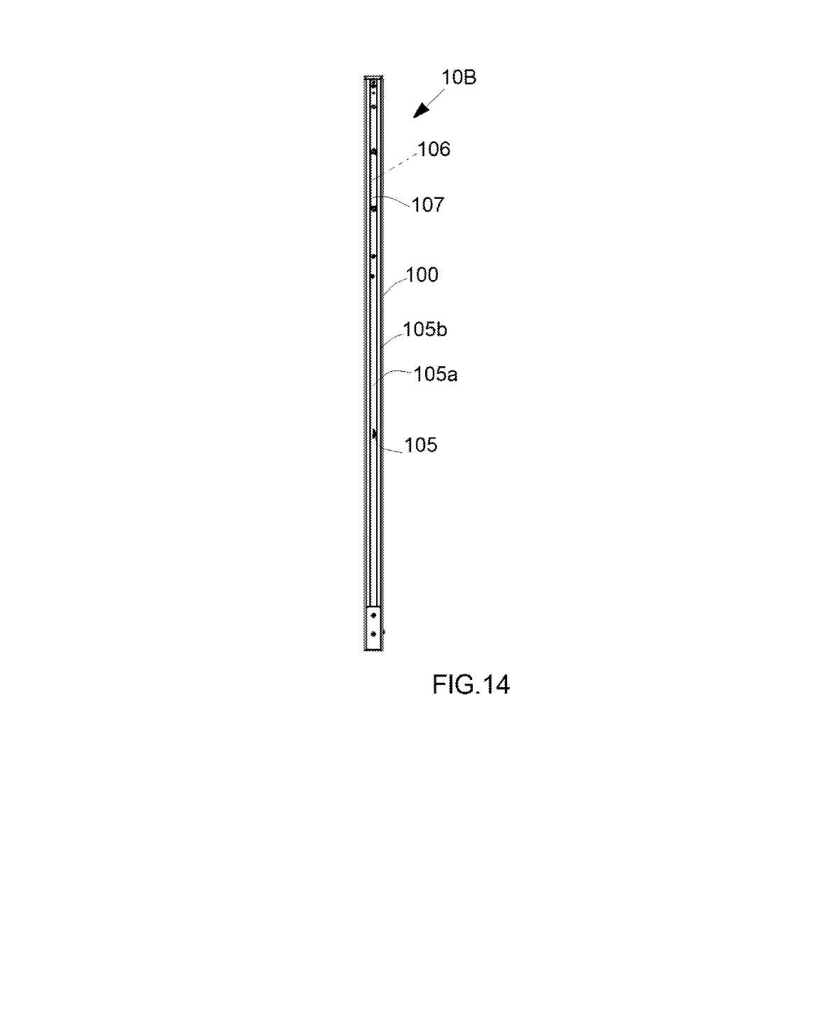

With reference to FIG. 14, and in a similar way to the upright 100 of the frame 10A mentioned above, the free-end upright 100 of the frame 10B has a through opening 106 at the top, the rectangular cross-section of which is adapted to the cross-section of the blackout slats 104 and allows each blackout slat 104 to be successively inserted into the frame 10B and each blackout slat 104 to be successively removed from the frame 10B, without disassembling the frame 10B, and by threading each blackout slat at one of its two ends through the free-end upright 100 of the frame 10B.

As with the pedestrian gate leaf 1A, the through opening 106 in the free-end upright 100 of the frame 10B can be closed by a cover plate 107.

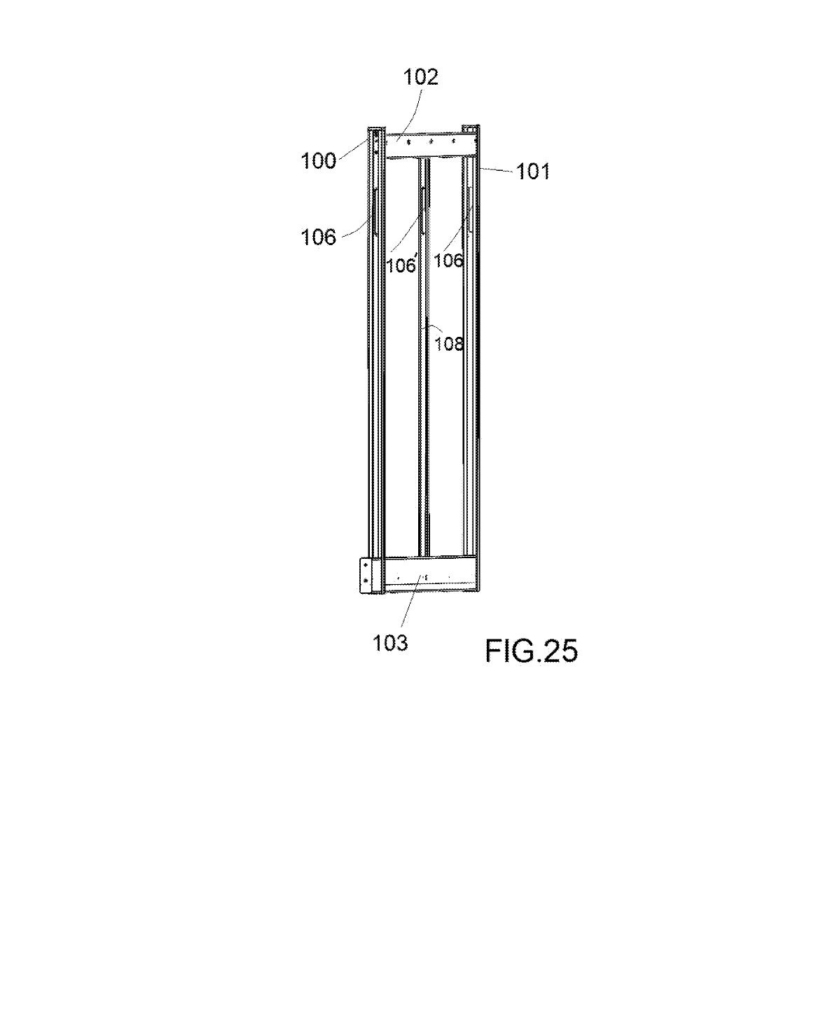

The mullion 108 of the driveway gate 1B also has (Fig.16 and Fig.25) a through opening 106’ at the top, the rectangular cross-section of which is adapted to the cross-section of the blackout slats 104 and allows each blackout slat 104 to be successively inserted into the frame 10B and each blackout slat 104 to be successively removed from the frame 10B, without disassembling the frame 10B, and by threading each blackout slat at one of its two ends through the mullion 108 of the frame 10B.

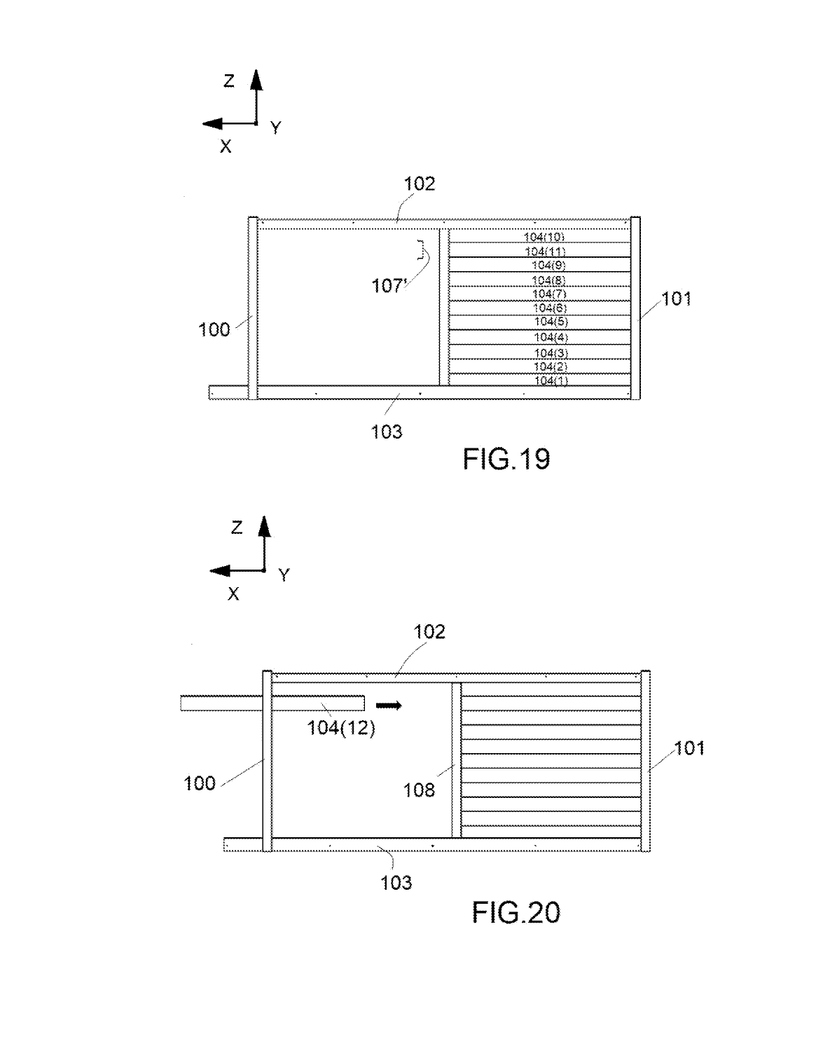

The through opening 106' of the mullion 108 of the frame 10B can be closed by a cover plate 107' (Fig.19).

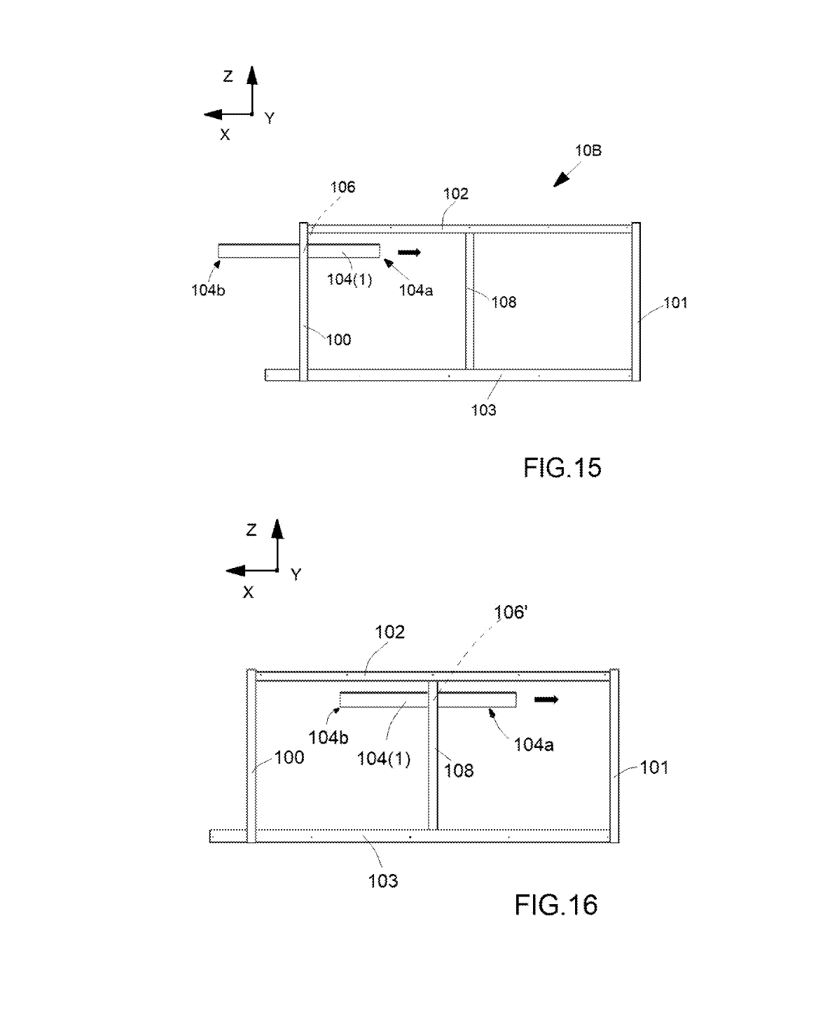

Referring to FIGS. 15 to 23, the blackout slats 104 can be mounted in the frame 10B without disassembling the frame 10B, and:

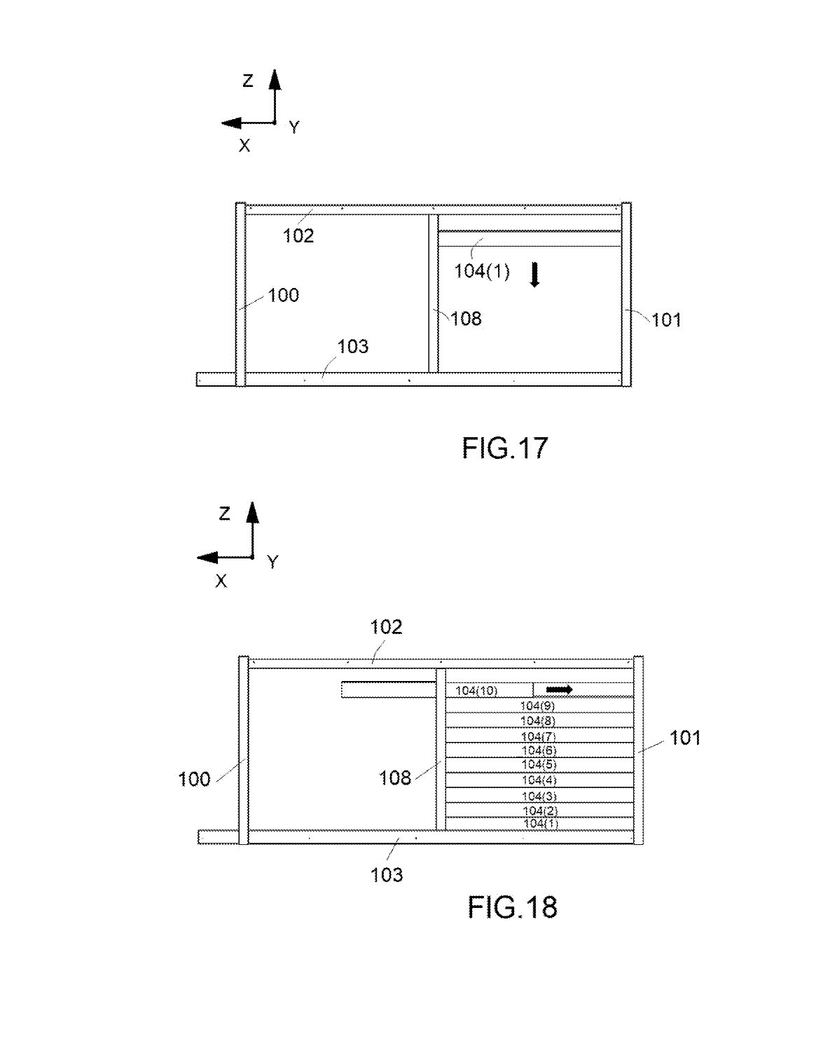

- FIG. 15 to FIG. 19: by successively passing the blackout slats 104(1) to 104(11) through the through openings 106 and 106' in the free-end upright 100 and mullion 108, respectively, so as to insert their ends into the receiving post 101 and mullion 108, and sliding them vertically in the frame (Fig.17), then closing the through opening 106' in the mullion 108 by means of the cover plate 107' (Fig.19).

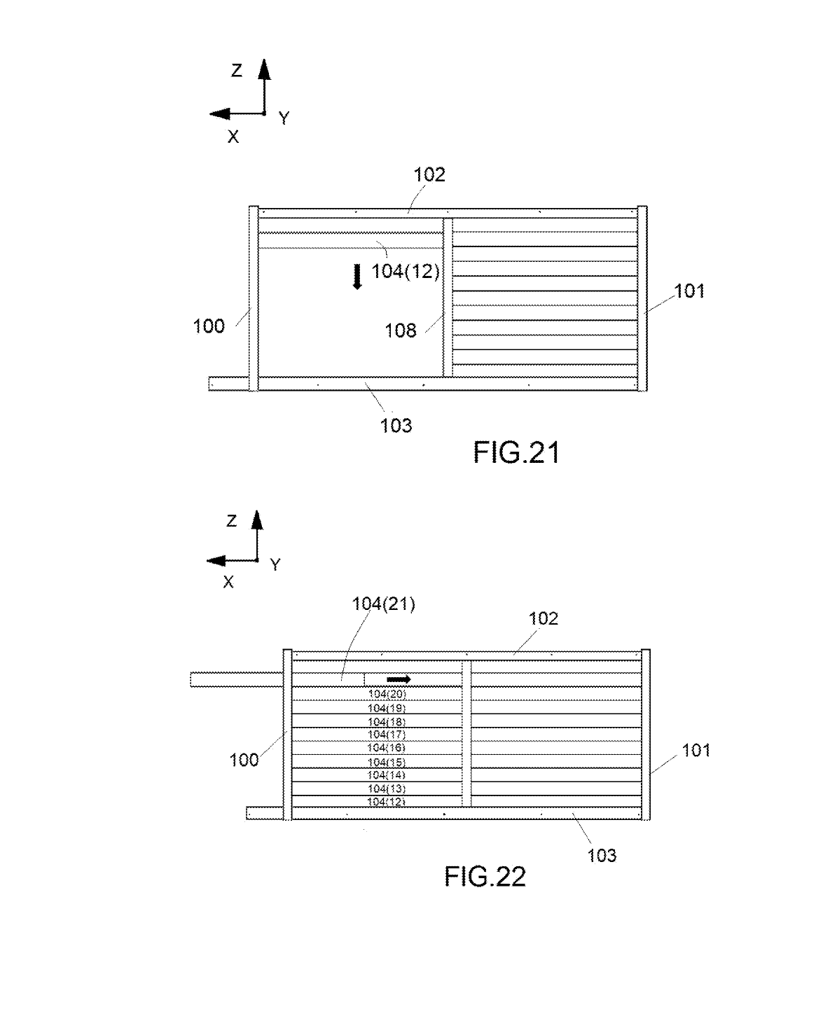

-FIG. Fig.20 to FIG. Fig.23: by successively passing the blackout slats 104(12) to 104(22) through the through opening 106 in the free-end upright 100, so as to insert their ends in the free-end upright 100 and in the mullion 108 and sliding them vertically in the frame (Fig.21), then closing the through opening 106 in the free-end upright 100 by means of the cover plate 107 (Fig.23).

In a similar way to the cover plate 107 of the pedestrian gate leaf 1A, the cover plates 107 and 107' of the driveway gate 1B can be permanently attached to the frame 10B once the slats 104 have been mounted in the frame 10B.

However, these cover plates 107 and 107' can advantageously be removably attached to the frame 10B, so that one or more blackout slats 104 can be removed. This removal can be useful when one or more slats 104 of the driveway gate leaf 1B are to be replaced.

When the covers 107 and 107' are removable, the blackout slats 104 can advantageously be removed from the frame 10B without disassembling the frame 10B, by temporarily removing the cover plate 107 and/or the cover plate 107' so as to free the through opening 106 and/or the through opening 106' and successively passing the blackout slat(s) through the through opening 106 and/or the through opening 106'.

By virtue of an aspect of the present disclosure, the frames 10A or 10B can be assembled without the blackout slats 104, for example on a first production site. The blackout slats 104 and assembled frames 10A or 10B can be stored on the same or another production site, and the pedestrian gate leaves 1A or driveway gate leaves 1B can be quickly and easily manufactured from these stocks of blackout slats 104 and frames 10A or 10B, by filling the leaf frames with blackout slats, without disassembling the frames.

By virtue of an aspect of the present disclosure, when the cover plate(s) 107, 107' are removable, it is also possible to quickly replace a blackout slat on a pedestrian gate leaf 1A or driveway gate leaf 1B, without disassembling the frame of the leaf.

### Other variants.

The present disclosure is not limited to the pedestrian gate leaf 1A and driveway gate leaf 1B of the appended figures. In particular, the disclosure covers the following non-exhaustive embodiments.

Alternatively, the two uprights 100 and 101 of the leaf 1A or 1B can each have a through opening 106 (as in the special case of FIG. 25), the cross-section of which is adapted to the blackout slats to allow them to be mounted in the frame 10A or 10B without disassembling the frame, and which can preferably each be closed by a closing cover 107.

The cover plate 107 and/or the cover plate 107' can be attached to the frame in such a way that it can be moved, for example by sliding or pivoting, relative to the frame between a closed position wherein the cover plate closes the corresponding through opening 106 or 106' and an open position wherein the corresponding through opening 106 or 106' is freed.

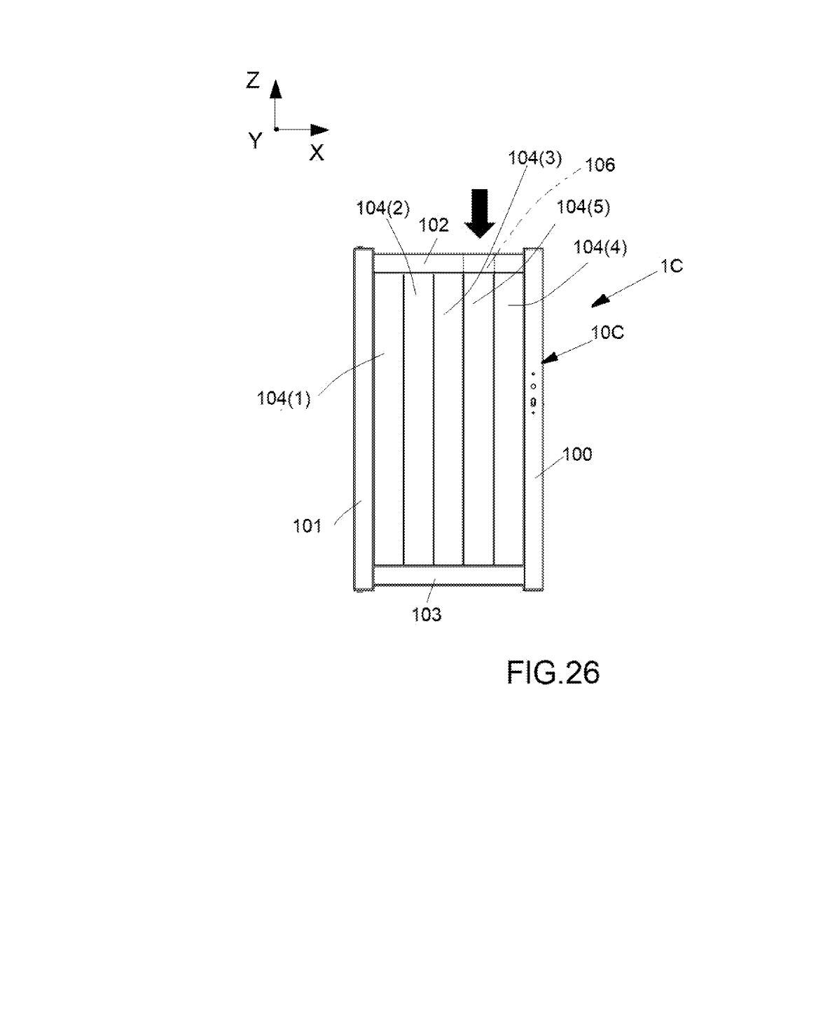

In another variant, as shown for example in FIG. 26 (in this FIG. 26, for ease of representation only, the width of the frame of the driveway gate has in practice been undersized in relation to the height of the frame), the blackout slats of the leaf 1C can be designed to be mounted in the frame 10C, oriented vertically in the same vertical plane. In this case, like the through opening 106 in the frame 10B or 10C mentioned above, a through opening 106 for successively threading each blackout slat into the frame, without disassembling it, can be made in one of the crosspieces 102 or 103, or in each crosspiece 102, 103 at any position along the crosspiece. In this case, each blackout slat 104 is successively inserted vertically into the frame 10C through said through opening 106 in the corresponding crosspiece, for example the upper crosspiece 102, so that the two ends 104a and 104b of the vertical blackout slat are inserted into the two crosspieces 102 and 103 and the blackout slat 104 can slide horizontally with respect to the two crosspieces 102, 103. Once the blackout slat 104 has been inserted into the frame 10C, it is slid horizontally into its final position in the frame, with the possible exception of the last blackout slat, which is inserted and positioned at said through opening.

Alternatively, the blackout slats 104, instead of being oriented vertically in the frame 10C, can be designed to be mounted in the frame 10C oriented obliquely (that is to say inclined to the vertical) in the same vertical plane.

Once inserted into the frame 10A 10B, or 10C, the blackout slats 104 are not necessarily abutting, but can be spaced apart by means of spacers in the frame.

The present disclosure is not limited to the production of a movable pedestrian gate leaf or driveway gate leaf, but can be applied to the production of any type of leaf, whether movable, semi-stationary or stationary.

An exemplary aspect of the present disclosure proposes a leaf, in particular a driveway gate or pedestrian gate leaf, which makes it possible to overcome the first disadvantage and/or the second disadvantage and/or the third disadvantage mentioned above in the Background section of the disclosure.

What is claimed is:

1. A leaf comprising:
a frame, said frame comprising at least two uprights connected by at least one upper crosspiece and by a lower crosspiece; and
blackout slats, said blackout slats having first and second ends and being configured to be inserted into said frame in a same vertical plane, wherein at least one of the at least two uprights and/or at least one of the at least one upper cross piece or the lower crosspiece comprises a first through opening, which is adapted to allow each blackout slat to be inserted into the frame successively without disassembling the frame and by successively threading the first or second end of each blackout slat through said first through opening in the at least one of the at least two uprights and/or the at least one of the at least one upper cross piece or the lower crosspiece.

2. The leaf according to claim 1, wherein said first through opening is adapted to allow the frame to be removed successively from each blackout slat, without disassembling the frame, and by passing each blackout slat through said first through opening in the at least one of the at least two uprights and/or the at least one of the at least one upper cross piece or the lower crosspiece.

3. The leaf according to claim 1, wherein the blackout slats can be inserted horizontally into the frame, through said first through opening, one above the other in the same vertical plane, either abutting or not abutting.

4. The leaf according to claim 1, wherein the at least one of the at least two uprights comprises the first through opening and said first through opening is positioned in an upper part of the at least one of the at least two uprights of the frame.

5. The leaf according to claim 1, wherein each blackout slat can be inserted horizontally into the frame through said first through opening and, once inserted, can slide vertically in the at least two uprights of the frame.

6. The leaf according to claim 1, including a mullion which vertically connects the the at least one upper cross piece and the lower crosspiece, and which has at least one second through opening, adapted to allow passage of at least one of the blackout slats through the mullion, without disassembling the frame.

7. The leaf according to claim 6, wherein each blackout slat can be inserted horizontally into the frame through said first through opening and, once inserted, can slide vertically in at least one of the at least two uprights of the frame and in the mullion of the frame.

8. The leaf according to claim 1, wherein the blackout slats can be inserted vertically and/or obliquely into the frame, side by side in the same vertical plane, either abutting or not abutting.

9. The leaf according to claim 1, wherein each blackout slat can be inserted vertically into the frame and, once inserted, can slide horizontally in the at least one upper cross piece and the lower crosspiece of the frame.

10. The leaf according to claim 1, having at least one closing cover, which is adaptable to the frame so as to close said first through opening or which is mounted on the frame and can be moved with respect to the frame, so as to close said first through opening.

11. The leaf according to claim 10, wherein said closing cover is removable from the frame or moved with respect to the frame to free up said first through opening.

12. The leaf according to claim 6, having at least one closing cover, which is adaptable to the frame so as to close said second through opening of the mullion or which is mounted on the frame and is movable with respect to the frame, so as to close said second through opening of the mullion.

13. The leaf according to claim 12, wherein the closing cover for closing said second through opening is removable from the frame or is movable with respect to the frame so as to free said second through opening of the mullion.

14. The leaf according to claim 1, wherein a cross-section of said first through opening is slightly larger than the cross-section of the blackout slats.

15. The leaf according to claim 1, constituting a pedestrian gate leaf or a driveway gate leaf.

16. A method of manufacturing a leaf , comprising:
providing a pre-assembled frame comprising at least two uprights connected by at least one upper crosspiece and by a lower crosspiece;
successively inserting at least two blackout slats having first and second ends into the frame in a same vertical plane, without disassembling the frame, by successively threading the first or second end through a first through opening of at least one of the at least two uprights and/or the at least one of the at least one upper cross piece or the lower crosspiece of the frame.

17. The method according to claim 16, comprising closing said first through opening by a cover plate once the blackout slats have been inserted in the frame.

18. The method according to claim 16, wherein the frame further comprises a mullion which vertically connects the at least one upper crosspiece and the lower crosspiece, and which has at least one second through opening, adapted to allow passage of at least one of the blackout slats through the mullion, without disassembling the frame, and the method comprises passing successively a plurality of the blackout slats through said second through opening of the mullion.

19. The manufacturing method according to claim 18, comprising closing said second through opening in the mullion of the frame by a cover plate, once the blackout slats have passed through the mullion.
